(19) United States
(12) Patent Application Publication
(10) Pub. No.: US 2010/0289342 A1
(43) Pub. Date: Nov. 18, 2010

(54) Space-Based Power Systems And Methods

(76) Inventor: William Eugene Maness, Everett, WA (US)

Correspondence Address: Eli Weiss, Esq.;Oakwood Law Group, LLP, 14 Bond Street -- SUITE 386, Great Neck, NY, 11021, US

(21) Appl. No.: 12/778,098

(22) Filed: May 11, 2010

Related U.S. Application Data
(60) Provisional application No. 61/177,565, filed on May 12, 2009.

(51) Int. Cl. H02J 17/00; B64G 1/10

(52) U.S. Cl. 307/104; 244/158.5

(57) ABSTRACT

Power supply satellites may be launched to LEO and boosted to GEO using power generated on board from solar insolation. A cluster of power production satellites may be operated as a phased antenna array to deliver power to one or more ground-based facilities, which may be located in different time zones.

### REFERENCE TO RELATED APPLICATIONS

This patent application claims the benefit of U.S. Provisional Application No. 61/177,565 filed on May 12, 2009, the disclosure of which is incorporated herein in its entirety by reference.

### BACKGROUND OF THE INVENTION

1. Field of the Invention

The present invention relates to systems, methods and apparatus generally related to space-based power production and transmission of generated power to ground-based facilities.

2. Description of Related Art

There is an ever-increasing need for power to use in ground-based activities. The primary source of power production is currently fossil fuel-based. However, fossil fuel-based power production has a number of disadvantages. Such disadvantages include a finite supply of fossil fuels, the need to transport fossil fuels to power production facilities, the relative inefficiencies of fossil fuel-based power production, and the pollution associated with fossil fuel based power production, including emission of carbon based “green house” gases.

Various alternative energy forms are currently being explored. Most alternative energy forms are based on solar insolation. One alternative form of energy production employs photovoltaic (PV) arrays as transducers to convert solar insolation into direct current (DC) electrical power. Another form employs solar insolation to heat a fluid in a boiler to produce a relatively high pressure gas to drive a turbine, which may produce alternating current (AC) electrical power. Various other forms are also being explored.

There are unfortunately a number of drawbacks to ground-based power production based on solar insolation. For example, the earth's atmosphere adversely lowers the efficiencies of ground-based power production. Also for example, ground-based power production facilities generally receive useful solar insolation for less than half of a day. Such adversely limits the total amount of power that may be generated. Such may also limit the ability to generate power when needed, particularly since electrical power is difficult to store.

A variety of proposals have been made to locate power production satellites in geosynchronous earth orbit (GEO) and to transmit generated power to ground-based facilities, for example, in the form of microwave electromagnetic energy. Such proposals are generally premised on placing relatively large satellites in GEO. Such satellites may produce power in response to solar insolation using a variety of methods, for example, photovoltaic (PV) arrays or thermal turbine generation systems. Placement in GEO provides a number of benefits. GEO places the satellite above the portions of the earth's atmosphere that adversely interfere with the solar insolation. Placement in GEO also provides longer periods of solar insolation than a low earth orbit.

Most importantly, placement in GEO allows the satellite to remain relatively fixed with respect to a ground-based facility. More specifically, by way of example, U.S. Pat. No. 7,612,284 to Rogers, et al. discloses a space-based power system that maintains proper positioning and alignment of system components without using connecting structures. Power system elements are launched into orbit, and the free-floating power system elements are maintained in proper relative alignment, e.g., position, orientation, and shape, using a control system.

U.S. Pat. No. 6,723,912 to Mizuno, et al. discloses a power generation satellite which has a photoelectric conversion unit for converting sunlight into electric energy, a transmission frequency conversion unit for performing frequency conversion of the electric energy to a microwave, a microwave control unit for controlling the amplitude, the phase, or the amplitude and the phase of the microwave, and a transmitting antenna for radiating the microwave. A plurality of the power generation satellites are placed in space to form a power generation satellite group and an array antenna having the transmitting antennas of the power generation satellites in the power generation satellite group as element antennas is formed.

U.S. Pat. No. 6,528,719 to Mikami, et al. discloses a space photovoltaic power generation system including a plurality of power satellites arranged in space, each of which converts electrical energy, into which sunlight has been photoelectric-converted, into a microwave, and transmits the microwave to an electric power base. The space photovoltaic power generation system divides the plurality of power satellites into a number of power satellite groups and adjusts the amount of phase adjustment to be made to a microwave which each of the plurality of power satellites included in each power satellite group will transmit so that a plurality of microwaves from the plurality of power satellites included in each power satellite group are in phase with one another.

U.S. Pat. No. 6,492,586 to Mikami, et al. discloses a space photovoltaic power generation system which can transmit a microwave of high power to an electric power base. As each of the plurality of power satellites changes its attitude in space, and its relative location therefore changes, each of the plurality of power satellites can adjust an amount of phase adjustment to be made to the microwave which each of the plurality of power satellites will transmit. A control satellite measures the location of each of the plurality of power satellites for the phase adjustment, and calculates the amount of phase adjustment for each of the plurality of power satellites. The control satellite then transmits the amount of phase adjustment to each of the plurality of power satellites.

Placing satellites in GEO is a complex and expensive task. The cost of placing a satellite in GEO is typically a function of the mass of the payload. Many proposals have employed payloads that were too massive to financially justify such endeavors.

Accordingly, there remains a need for improved and simplified methods, systems, and apparatus for producing power at space-based facilities and transmitting such power to ground-based facilities.

### SUMMARY OF THE INVENTION

A solar power satellite may be summarized as including a power transducer that converts solar insolation into electrical power; and an electrical propulsion system coupled to the power transducer to receive at least a portion of the electrical power converted from the solar insolation and operable during at least one mission phase to boost the satellite from a low earth orbit to a geosynchronous earth orbit.

The electrical propulsion system may be configured to boost the satellite from the low earth orbit in successive operations which each occur during a respective portion of each of a plurality of orbits during which the power transducer receives the solar insolation. The use of electrical power generated by the transducer that will also provide power to the transmission system when the satellite is in its final orbit may reduce the need for orbital transfer fuel. The electrical propulsion system may be directly coupled to the power transducer without any intervening electrical battery or ultra-capacitor. The satellite may further include at least one power transmission antenna that can be oriented toward the earth while the satellite is in the geosynchronous earth orbit; and at least one power transmitter coupled to drive the at least one power transmission antenna with at least a portion of the electrical power converted from the solar insolation by the power transducer to transmit power that is not modulated with any communications data from the satellite towards the at least one ground-based power reception antenna. The satellite may further include at least one power transmitter operable to cause at least a portion of the electrical power converted from the solar insolation by the power transducer to be provided as a non-communications electromagnetic power transmission towards at least one earth-based receiver.

The satellite may further include at least a first antenna to receive a pilot signal from a ground-based transmitter; at least a second antenna to receive a reference signal from a space-based transmitter; at least one power transmission antenna that can be oriented toward the earth while the satellite is in the geosynchronous earth orbit; and at least one power transmitter operable to cause at least a portion of the electrical power converted from the solar insolation by the power transducer to be provided as a non-communications electromagnetic power transmission towards at least one earth-based receiver with a phase that is responsive to a differential between the pilot signal and the reference signal. The satellite may further include a controller that determines the differential between the pilot signal and the reference signal, wherein the satellite is one or a plurality of satellites each of which provides a respective electromagnetic power transmission towards the at least one earth-based receiver with respective phases controlled to form a phased array antenna. The electrical propulsion system may be operable during at least another mission phase during geosynchronous earth orbit to change a position of the satellite relative to at least one other satellite. The power transducer may include at least one of a photovoltaic array system or a closed loop boiler and turbine system and the electrical propulsion system includes at least one of a Hall effect drive or an ion drive.

A method of operating a satellite may be summarized as including placing the satellite in a low earth orbit; converting solar insolation into electrical power on board the satellite; and driving an electrical propulsion system using the electrical power converted from the solar insolation to boost the satellite from the low earth orbit to a geosynchronous earth orbit.

Driving an electrical propulsion system using the electrical power converted from the solar insolation to boost the satellite from the low earth orbit to a geosynchronous earth orbit may include driving the electrical propulsion system in successive operations which each occur during a respective portion of each of a plurality of orbits during which the power transducer of the satellite receives the solar insolation. Driving the electrical propulsion system in successive operations which each occur during a respective portion of each of a plurality of orbits during which a power transducer of the satellite receives the solar insolation may include driving the electrical propulsion system for successively longer periods during each successive operation to successively circularize the orbit of the satellite. Driving an electrical propulsion system using the electrical power converted from the solar insolation to boost the satellite from the low earth orbit to a geosynchronous earth orbit may include directly coupling the electrical propulsion system to a power transducer of the satellite without any electrical battery, ultra-capacitor, solid fuel propellant or chemical fuel propellant.

The method may further include driving at least one power transmission antenna by a power transmitter with at least a portion of the electrical power converted from the solar insolation by a power transducer of the satellite to transmit power that is a non-communications electromagnetic power beam from the satellite towards at least one ground-based antenna. The method of may further include determining a differential between a pilot signal and a reference signal; and adjusting a phase of the non-communications electromagnetic power beam to form a phased antenna array with a respective power transmission antenna of each of a plurality of other satellites. The method may further include changing a position of the satellite relative to at least one other satellite during a geosynchronous earth orbit mission phase.

A space-based power supply system to supply power to remote facilities may be summarized as including a plurality of satellites, each of the satellites in geosynchronous orbit and physically uncoupled from one another, at least three of the satellites each including a respective power transducer that converts solar insolation into electrical power and a respective power transmission system including at least one power transmission antenna, wherein each of the at least three satellites receive at least one signal to synchronize the power transmission antennas of each of the power transmission systems as a phased antenna array to transmit the electric power converted from the solar insolation in the form of electromagnetic energy that is not modulated with communications data to a remote non-space-based facility.

One of the plurality of satellites may not include a respective power transmission system, and may include a synchronization system that includes at least one synchronization antenna and at least one synchronization transmitter that transmits a reference signal to at least some of the at least three satellites which include the respective power transmission systems, which reference signal provides a basis to synchronize a phase of each of the power transmission antennas as a phased antenna array. One of the at least three satellites which may include a respective power transmission system may further include a synchronization system that may include at least one synchronization antenna and at least one synchronization transmitter that transmits a reference signal to at least some of the other ones of the at least three satellites, which reference signal provides a basis to synchronize a phase of each of the power transmission antennas as a phased antenna array. Each of the at least three satellites may include a receiver that receives a pilot signal from the non-space-based facility. Each of the at least three of the satellites may include a respective controller that controls the respective power transmission system based at least in part on a differential between the pilot and the reference signals to achieve the phased antenna array. Each of the at least three satellites may include a respective electric propulsion system coupled to receive electrical power from the at least one power transducer and selectively operable to change a position of the satellite with respect to the other ones of the at least three satellites while in geosynchronous orbit. The electric propulsion system may be coupled to receive power from the respective power transducer and is further operable to boost the satellite from the geosynchronous orbit from a low earth orbit solely using electrical power converted from the solar insolation by the power transducer.

A method of operating a plurality of satellites to provide power from space may be summarized as including converting solar insolation into power by a respective power transducer of each of a plurality of satellites in geosynchronous orbit, at least two of the satellites physically uncoupled from one another; receiving a pilot signal at each of at least some of the satellites in geosynchronous orbit; and operating a respective power antenna of each of at least some of the satellites in geosynchronous orbit a phased antenna array based at least in part on the received pilot signal to selectively delivering at least 1 Megawatts of power from the phased antenna array.

Operating a respective power antenna of each of at least some of the satellites in geosynchronous orbit a phased antenna array based at least in part on the received pilot signal to selectively delivering at least 1 Megawatt of power from the phased antenna array may include operating a respective power antenna of each of at least some of the satellites to transmit electromagnetic power that has not been modulated with communications information. The method may further include receiving a reference signal by at least some of the satellites; determining a differential between the received reference and pilot signals; and operating a respective power transmitter of each of at least some of the satellites based on the determined differential between the received reference and pilot signals. The method may further include boosting each of the satellites from low earth orbit into a respective geosynchronous orbit using power converted on board the satellite solely from solar insolation. The method of may further include adjusting a position of one of the satellites with respect to at least one other of the satellites using power converted on board the satellite solely from solar insolation. The method may further include determining that one of the satellites in geosynchronous orbit is malfunctioning; launching a new satellite into a low earth orbit in response to determining that one of the satellites in geosynchronous orbit is malfunctioning; boosting the launched new satellite from the low earth orbit to the geosynchronous orbit using power converted solely from solar insolation by a power transducer of the new satellite.

A ground-based power supply system may be summarized as including a pilot signal transmitter that provides a basis to synchronize transmission from each of a plurality of power transmission antennas of a plurality space-based power supply satellites to operate as a phased array antenna; a first plurality of earth-based power rectennas positioned to receive power in the form of electromagnetic energy transmitted from the power transmission antennas of the plurality of power supply satellites when power transmission antennas of the power supply satellites operate as the phased antenna array; and at least one power converter coupled to receive power from at least one of the power rectennas and configured to convert the received power to an alternating electric current for delivery to a power grid.

Each of the first plurality of power rectennas may comprise a net. The first plurality of power rectennas may form an elliptical rectenna array and the at least one power converter may include at least three power converters distributed at various locations about the elliptical rectenna array. The at least one power converter may include an inverter configured to convert a direct electrical current to an alternating electrical current and a transformer to step up a voltage of the alternating electrical current. The ground-based power supply system may further include a number of switches selectively operable to electrically couple at least two of the rectennas of the first plurality in parallel to one another. The ground-based power supply system may further include a number of switches selectively operable to electrically couple at least two of the rectennas of the first plurality in series to one another. The ground-based power supply system may further include a switching system operable to switch the transmission of electromagnetic energy by the plurality of supply satellites to at least a second plurality of earth-based power rectennas that form a second rectenna array remotely located from the first rectenna array. The first and the second rectenna arrays may be located in different time zones from one another.

A method of operating a ground-based power supply system may be summarized as including transmitting a pilot signal that provides a basis to synchronize transmission from each of a plurality of power transmission antennas of a plurality space-based power supply satellites to operate as a phased array antenna; receiving power in the form of electromagnetic energy at a first plurality of earth-based power rectennas from the power transmission antennas of the plurality of power supply satellites when power transmission antennas of the power supply satellites operate as the phased antenna array; and converting by at least one ground-based power converter the power received at the first plurality of power rectennas to an alternating electric current for delivery to a power grid.

The method of operating a ground-based power supply system may further include coupling at least two ground-based power converters electrically in at least one or series or parallel. The method of operating a ground-based power supply system may further include from time-to-time transmitting a signal to the space-based power supply satellites that causes phased antenna array formed by the power transmission antennas of the space-based power supply satellites to change a directional component of the transmission of electromagnetic energy to switch between the first plurality of earth-based power rectennas and at least a second plurality of earth-based power rectennas located in different time zone than the first plurality of earth-based power rectennas.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of a plurality of power production satellites in geosynchronous earth orbit (GEO) receiving solar insolation from the sun and operating as a phased antenna array to deliver power to various ground-based facilities according to an embodiment of the invention;

FIG. 2 is a schematic diagram of various systems of a power production satellite according to an embodiment of the invention;

FIG. 3 is an isometric view of a power production satellite employing PV arrays according to an embodiment of the invention;

FIG. 4 is an isometric view of a power production satellite employing a thermal power generation system according to another embodiment of the invention;

FIG. 5 is a schematic diagram showing placement of a power production satellite into GEO according to an embodiment of the invention;

FIG. 6 is a view of the earth illustrating the relative positions of a number of ground-based facilities according to an embodiment of the invention;

FIG. 7 is a schematic diagram of a ground-based facility including a plurality of power receiving antennas, various electrical converting and/or conditioning elements to provide power to a grid, and ground-based communications facilities according to an embodiment of the invention;

FIG. 8 is an isometric view of a number of rectennas that may be employed by a ground-based facility according to an embodiment of the invention;

FIG. 9 is a flow diagram of a method of operating a space-based satellite to produce power and provide power to a ground-based facility according to an embodiment of the invention;

FIG. 10 is a flow diagram of a method of transferring a power production satellite from low earth orbit (LEO) to GEO according to an embodiment of the invention;

FIG. 11 is a flow diagram showing a method of providing power to a propulsion system of a space-based satellite according to an embodiment of the invention;

FIG. 12 is a flow diagram showing a method of operating a number of space-based power production satellites as a phased antenna array according to an embodiment of the invention;

FIG. 13 is a flow diagram showing a method of operating a plurality of space-based power production satellites as a phased antenna array to provide power to ground-based facilities according to an embodiment of the invention;

FIG. 14 is a flow diagram showing a method of maintaining an array of space-based power production satellites according to an embodiment of the invention;

FIG. 15 is a flow diagram showing a method of operating a ground-based facility to receive power from a number of space-based power production satellites according to an embodiment of the invention; and

FIG. 16 is a flow diagram showing a method of operating a ground-based facility to cause a number of space-based power production satellites to function as a phased antenna array according to an embodiment of the invention.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures and methods associated with space-based power systems including PV-arrays, thermal turbine systems, propulsion systems, communications systems and launch vehicles have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

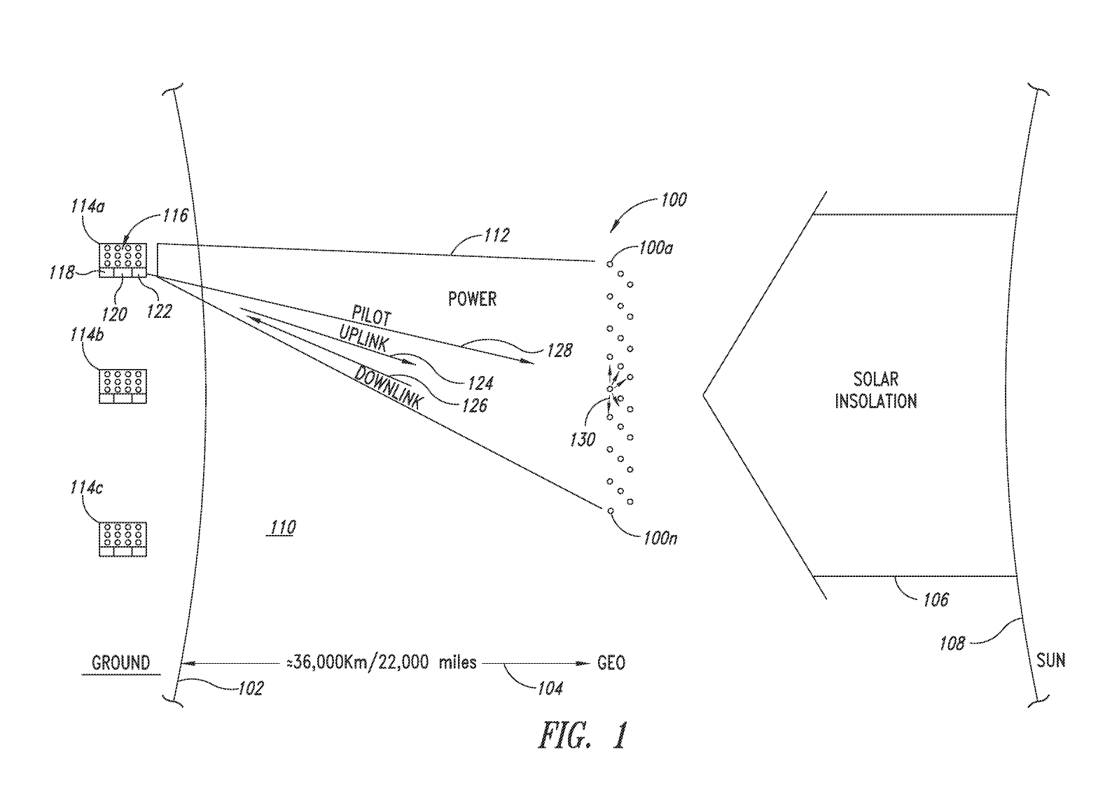

FIG. 1 shows a plurality of satellites 100a-100n (collectively 100) positioned above ground 102 in geosynchronous earth orbit (GEO) 104 according to one illustrated embodiment.

At least some, and typically all, of the satellites 100 are capable of producing power from solar insolation 106 that comes from a star such as the sun 108, and hence are denominated as power production satellites. By locating the power production satellites 100 in GEO 104, many adverse effects by the earth's atmosphere 110 are substantially avoided. Thus, the power production satellites 100 receive significantly more solar insolation 106 than would be received by ground-based power production system or low earth orbit—(LEO) based power production systems. GEO allows the power production satellites to receive solar insolation approximately 92% of the time. Solar flux is approximately twenty-five times the amounts of solar flux received on the ground. While this description often refers to the earth (e.g., LEO, GEO, earth) and/or to the sun (e.g., sun, solar), the teachings herein are applicable to other celestial bodies. For example, power production satellites 100 may orbit another planet or a moon and transmit power 112 to ground-based facilities 114 on that other planet or moon.

The power production satellites 100 are typically physically uncoupled from one another while in GEO. The total number of power production satellites 100 may vary based on the desired amount of total power production capacity and on the specific size or power production capacity of any individual one of the power production satellites 100. A typical embodiment of the systems described herein may include approximately 100 or more power production satellites in a cluster or array. As used herein and in the claims, the term “array” is used interchangeably with the term “cluster” and is not intended to require any particular order or arrangement (e.g., rows and columns) of the power production satellites. Rather, the term “cluster” or “array” is used to denote a group or set of power production satellites that are operated collectively to form a phased antenna array for transmission of power 112 to one or more ground-based facilities 114a [symbol] 114c (collectively 112).

The ground-based facilities 114 may include a plurality of antennas 116 (e.g., rectennas), power conversion and/or conditioning components 118, uplink/downlink transmission system 120, and pilot transmission system 122. As described in more detail below, the power conversion and/or conditioning system 118 may employ various components to convert and/or condition electrical power, for example, DC/DC power converters, DC to AC power inverters, AC to DC power rectifiers, and various transformers and filters. The uplink/downlink communications system 120 may include one or more antennas, transmitters, and/or receivers (e.g., transceivers) to provide uplink communications 124 from the ground-based facility 114a to the satellites 100. Likewise, the uplink/downlink communications systems may include one or more antennas, transmitters and/or receivers to provide downlink communications from the satellites 100 to the ground-based facility 114. Such uplink and downlink communications 124, 126 may include instructions and/or data modulated as a communication signal.

Such communication signals may take the form of modulations imposed on a carrier wave (e.g., radio, microwave, light). The pilot transmission system 122 may provide a pilot beam 128 to the satellites 100, which allow the satellites to function as elements of a phased antenna array.

Additionally, one or more of the power production satellites 100 may communicate 130 (only one called out in FIG. 1) with one more of the other ones of the power production satellites 100. Such communications 130 may take the form of reference signals indicative of an absolute position of the power production satellite 100 in some reference frame or indicative of a relative position of the power production satellite 100 with respect to at least one other one of the power production satellites 100. As explained in more detail below, such may allow the cluster or array of power production satellites 100 to operate or function as a phased antenna array. Such may alternatively or additionally allow the power production satellites 100 to be repositioned or reoriented with respect to one another to at least approximately maintained a desired position or orientation via station keeping maneuvers.

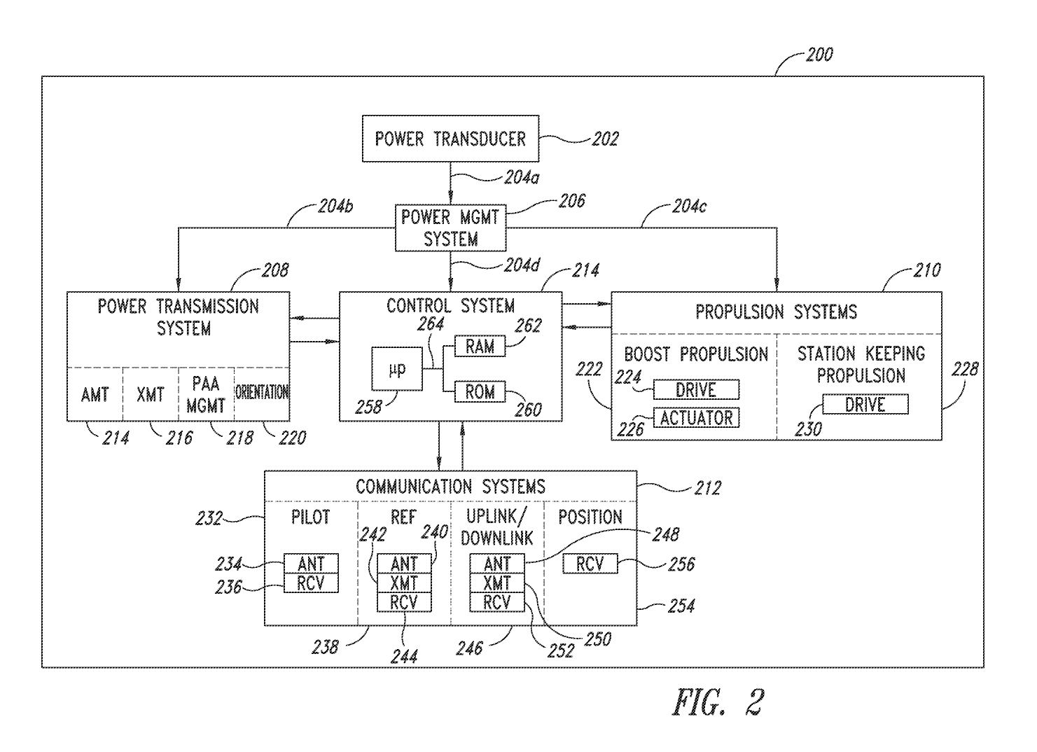

FIG. 2 shows various systems and subsystems of a power production satellite 200, according to one illustrated embodiment.

The power production satellite 200 includes a power transducer that changes solar insolation into a useful form. For example, the power transducer 202 may change electrical insolation into electrical power, for example into direct current (DC) electrical power. The electrical power may be provided to various other systems of the power production satellite 200 via one or more electrical buses 204a-204d (collectively 204). The electrical buses 204 may take the form of DC electrical buses and/or AC electrical buses.

The power production satellite 200 may include a power management system 206 which may convert and/or condition electrical power received from the power transducer 202 via a first electrical bus 204a into a form suitable for delivery via the other electrical buses 204b-204d. For example, the power management system 206 may receive DC power from the power transducer 202 via the first electrical bus 204a. The power management system 206 may convert and/or condition the DC power to supply the various other systems of the power production satellite 200 via power buses 204b-204d. The power management system 206 may include one or more DC/DC power converters, one or more AC to DC power inverters, one or more AC to DC rectifiers, one or more transformers, and one or more filters.

The power production satellite 200 may include a power transmission system 208, one or more propulsion systems 210, one or more communications systems 212, and one or more control systems 214.

The power transmission system 208 may take a variety of forms. For example, the power transmission system 208 may include one or more antennas or antenna elements 214 which may be generally oriented or orientable towards the ground. The power transmission system 208 may include one or more transmitters coupled to cause the antenna(s) 214 to transmit power toward a ground-based facility. For example, the transmitters 216 may cause the antenna(s) 214 to emit electromagnetic energy in the microwave portion (e.g., 5.8 GHz) of the electromagnetic spectrum toward a ground-based facility. The power transmission system 208 may also include a phased antenna array (PAA) management subsystem 218. The PAA management subsystem 218 may control the transmitter 216 to cause the antenna 214 to transmit as part of a phased antenna array along with antennas 214 of other power production satellites. The power transmission system 208 may optionally include an orientation system 220. The orientation system 220 may control a direction or orientation of the antenna(s) 214. Such may allow more precise pointing of the antenna(s) 214 towards a ground-based facility. The power transmission system may receive electrical power via a second power bus 204b.

The propulsion systems 210 may include a boost propulsion subsystem 222 used to boost the power production satellite 200 from LEO to GEO as described further herein. The boost propulsion subsystem 222 may include an electric drive 224, for example an electric propulsion drive (e.g., ion drive, Hall effect drive). The electric drive 224 may advantageously receive electrical power via a third power bus 204c. The boost propulsion subsystem 222 may further include one or more actuators 226 where a nozzle of the electric drive 224 is gimbaled.

The propulsion systems 210 may also include station-keeping propulsion subsystem 228. The station-keeping propulsion subsystem may include one or more drives 230, for example electric propulsion drives (e.g., ion drives, Hall effect drives). The drives 230 of the station-keeping propulsion subsystem 228 may be distributed about the power-producing satellite 200. The drives may be selectively activated to effect a positioning or orientation of the power production satellite 200 while in GEO, for example to change a position and/or orientation with respect to one or more other power production satellites in a cluster or array. The drive(s) 230 may advantageously receive electrical power via the third power bus 204c, via some other power bus or may employ a chemical propellant.

The communications systems 212 may include a variety of subsystems and/or elements. For example, the communications systems 212 may include a pilot subsystem 232 to receive a pilot beam from one or more ground-based facilities. The pilot subsystem 232 may include one or more antennas 234 and one or more receivers 236. Thus, the power production satellite 200 may receive a pilot beam from a ground-based facility which may allow synchronization between various space-based power production satellites to function as a phased antenna array, as detailed further herein. The pilot beam approach may be advantageous in that the pilot beam as received by each power production satellite includes an inherent phase shift which represents an amount of compensation required by the respective satellite to form the phased antenna array. The communications systems 212 may include a reference subsystem 238. The reference subsystem 238 may include an antenna 240, a transmitter 242, and/or a receiver 244. The reference subsystem 238 may produce and transmit a reference signal to other power production satellites in a cluster or an array as well as receive reference signals from one or more of those power production satellites. A controllable phase shifter may be included. Such further allows the cluster or array of power production satellites to function as a phased antenna array to transmit power to one or more ground-based facilities.

The communications systems 212 may also include one or more uplink/downlink subsystems 246. The uplink/downlink communication subsystem 246 may include one or more antennas 248, transmitters 250, and/or receivers 252. The uplink/downlink communication subsystem 246 provides communications with one or more ground-based facilities. Such may allow the transmission of data or other information from the power production satellite 200 to the ground-based facility. Such may also allow the transmission of data and/or instructions from the ground-based facility to the power production satellite 200. Such may allow the reprogramming of one or more systems of the power production satellite 200 after launch into LEO or boost into GEO. The communications systems 212 may also include a positioning subsystem 254. The positioning subsystem 254 may take any of a variety of forms that allow a satellite to determine the satellite's position with respect to some reference frame. For example, the positioning subsystem 254 may include a receiver 256, for example a global positioning system receiver. Other radio or microwave-based systems may be employed, as well as systems that employ lasers or other optical devices for determining distances or positions in some global reference frame or relative to one or more of the other satellites in a cluster or array. Information determined using the positioning system may be used to operate the station keeping propulsion system 228 to maintain or to change a position and/or orientation of the satellite 200, for example while in GEO.

The control system 214 may take a variety of forms capable of controlling one or more systems and/or subsystems of the power production satellite. The control system 214 may include one or more processors 258 as well as one or more memories, such as read-only memory (ROM) 260 and/or random access memory (RAM) 262 coupled to the processor 258 via one or more buses 264. The buses 264 may take a variety of forms including one or more power buses, instruction buses, and data buses. The ROM 260 may store processor executable instructions that cause the processor 258 to control the various other systems of the power production satellite 200. Likewise, RAM 262 may store instructions and/or data executable by the processor 258 for controlling the various other systems of the power production satellite 200. In some embodiments, the power management system 206, power transmission system 208, propulsions systems 210, and/or communications systems 226 may include respective control systems having respective processors and memories. Such may be in addition to, or in place of the control system 214. The control system 214 may receive power, for example DC electrical power, via a fourth electrical bus 204d.

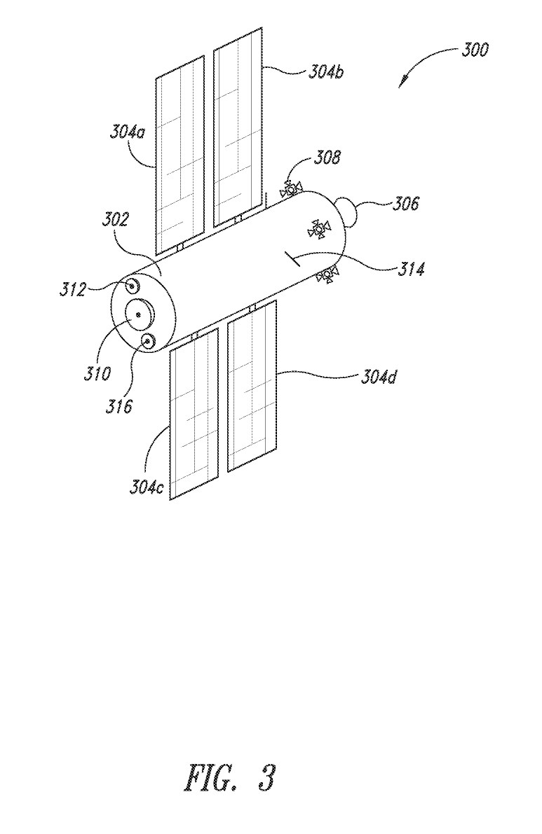

FIG. 3 shows a power production satellite 300 according to one illustrated embodiment.

The power production satellite 300 may include a main body 302 with one or more PV arrays 304a-304d (collectively 304) to produce DC electrical power from solar insolation. While four PV arrays 304 are illustrated, the power production satellite 300 may include a greater or less number of PV arrays 304. The PV arrays 304 may be movable from a retracted or stowed configuration to an extended or deployed configuration. Such may allow the power production satellite 300 to be received within a launch vehicle for launch into LEO, for example via one or more stages of a chemical propulsion-based rocket. Once in LEO, the PV arrays 304 may be extended or deployed to start producing electrical power which may be employed to power a boost propulsion drive to gradually boost the power production satellite 300 from LEO to GEO. A variety of mechanisms may be employed to deploy the PV arrays 304. For example, the PV arrays 304 may be deployed using a mechanical system including an electric motor and a linkage, may be biased into a deployed position via spring members, or may be inflated via a suitable compressor or source of compressed fluid (e.g., a pressurized liquid or a gas). For instance, the PV array may include an inflatable peripheral ring with a number of support cables extending inwardly toward a center, which supports thin film solar cell panels.

The power production satellite 300 may include one or more boost propulsion nozzles 306 for directing thrust in boosting the power production satellite 300 from LEO to GEO. The boost propulsion nozzles 306 may or may not be gimbaled. The power production satellite 300 may also include station-keeping nozzles 308 (only one set called out in FIG. 3) that allow a position and/or orientation of the power production satellite 300 to be maintained or corrected in GEO.

The power production satellite 300 may include one or more power transmission antennas 310 selectively operable to transmit power to a ground-based facility. The transmitted power may take the form of a power transmission that is noncommunicative and thus which is not modulated with communications information. The power transmission is typically at a level of power far exceeding the power level associated with typical satellites communications. The power production satellite 300 may also include one or more pilot beam antennas 312 which may receive a pilot beam from a ground-based facility. The power production satellite 300 may further include one or more reference signal antennas 314 (only one called out in FIG. 3) which may be positioned to allow communication of reference signals between various power production satellites in a cluster or array. The power production satellite 300 may further include one or more uplink/downlink communications antennas 316 positioned and selectively operable to receive and/or transmit information, data, and/or instructions between the power production satellite 300 and a ground-based facility.

FIG. 4 shows a power production satellite 400 according to another illustrated embodiment.

The power production satellite 400 may include a main body 402 with one or more thermal power generation system 404 (one illustrated in FIG. 4) to produce AC electrical power from solar insolation. The thermal power generation system 404 may include a boiler 404a coupled to a turbine 404b to form a closed loop thermal power generation system. The thermal power generation system 404 may optionally include one or more solar concentrators 404c (two called out in FIG. 4) that concentrate solar insolation on the boiler 404a. For example, the concentrators 404c may take the form of one or more mirrors and/or lenses positioned or positionable to focus solar insolation on the boiler 404a. The solar concentrators 404c may be shaped (e.g., concave or parabolic) to focus the insolation on the boiler 404a. The concentrators 404c may be mounted on respective arms or struts 404d (only one called out in FIG. 4). The struts 404d may be movable between a stowed and a deployed configuration. Such may allow the power production satellite 400 to be received within a launch vehicle for launch into LEO, for example via one or more stages of a chemical propulsion-based rocket. Once in LEO, the arms or struts 404d may be extended or deployed to position the solar concentrators 404c to focus solar insolation to heat a fluid in the boiler 404a in order to drive the turbine 404b to start producing electrical power. The electrical power may advantageously be employed to power a boost propulsion drive to gradually boost the power production satellite 400 from LEO to GEO.

The power production satellite 400 may include one or more boost propulsion nozzles 406 for directing thrust in boosting the power production satellite 400 from LEO to GEO. The propulsion nozzle 406 may or may not be gimbaled. The power production satellite 400 may also include station-keeping nozzles 408 (only one set called out in FIG. 4) that allow a position and/or orientation of the power production satellite 400 to be maintained or corrected in GEO.

The power production satellite 400 may include one or more power transmission antennas 410 positioned or positionable and selectively operable to transmit power to a ground-based facility. As previously noted, the transmitted power may take the form of a power transmission which is noncommunicative and thus which is not modulated with communications information. The power production satellite 400 may also include one or more pilot beam antennas 412 which may receive a pilot beam from a ground-based facility. The power production satellite 400 may further include one or more reference signal antennas 414 (only one called out in FIG. 4) positioned to allow communication of reference signals between various power production satellites in a cluster or an array. The power production satellite 400 may further include one or more uplink/downlink communications antennas 416 positioned or positionable and selectively operable to receive and/or transmit information, data, and/or instructions between the power production satellite 400 and a ground-based facility.

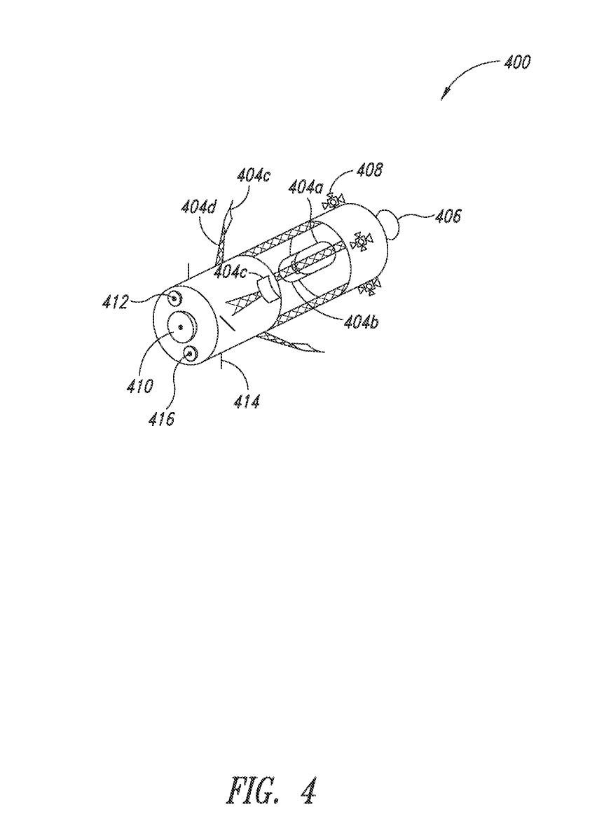

FIG. 5 illustrates how a power production satellite 500 may be put into GEO 502 according to one illustrated embodiment.

The power production satellite 500 may be launched from a celestial body such as the earth 504. For example, one or more stages of a chemical-based or solid fuel-based rocket may launch the power production satellite 500 during a launch phase graphically represented by an inner portion 506 of a trajectory or orbit illustrated in FIG. 5. The launch phase 506 may place the power production satellite 500 into an LEO 508 (e.g., approximately 300 miles).

Once in LEO, suitable power production structures on the power production satellite 500 may be deployed. For example, PV arrays may be deployed via one or more actuators (e.g., motors, solenoids, springs, pumps, compressors, pressurized reservoir). Also for example, arms or struts holding lenses, reflectors or other solar concentrators may be deployed.

The power production satellite 500 receives solar insolation 510 while in LEO. At least some power generated from the solar insolation 510 may be employed to boost the power production satellite 500 from LEO 508 to GEO 502. For example, the power production satellite 500 receives solar insolation 510 over some portion of each orbit starting at a first position 512 in the orbit and ending at a second position 514 in the orbit. Power produced during the portion of the orbit between the start and the end 512, 514 when the power production satellite 500 receives insolation may be used to power an electric drive to boost the power production satellite 500 to GEO 502. Thus, the power production satellite 500 may be gradually or incrementally boosted from LEO 508 to GEO 502. The portion of each orbit in which the power production satellite 500 receives solar insolation 510 may gradually increase as the power production satellite approaches GEO from LEO. Additionally, the solar flux received by the power production satellite 500 may increase as the power production satellite approaches GEO and the atmosphere filters less of the solar insolation. Thus, the amounts of power available for boost propulsion will gradually increase with each orbit. This gradual transition between LEO 508 and GEO 502 is illustrated by ellipses 516. The increase in power, and hence boost propulsion may assist in circularizing the orbit as GEO 502 is approached from LEO 508.

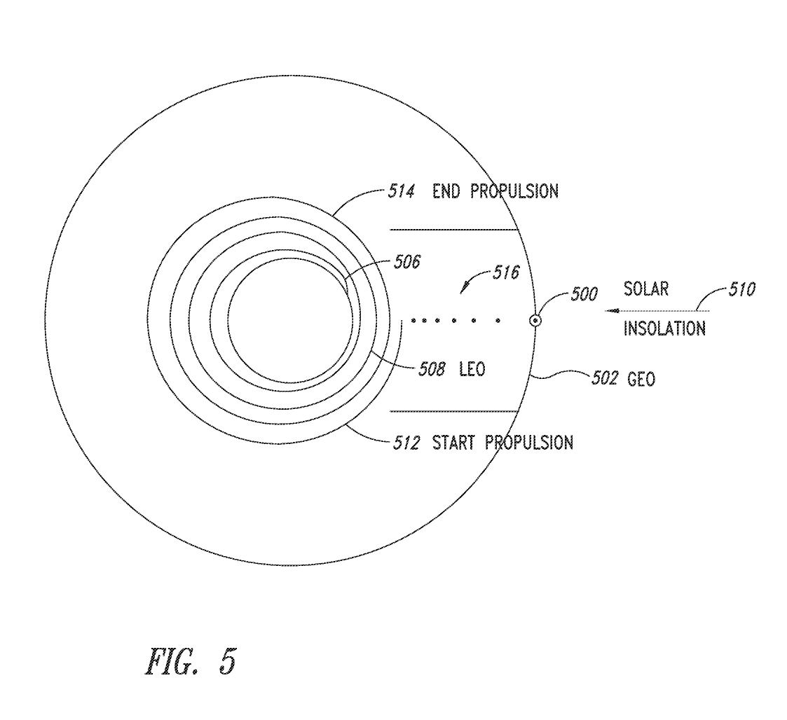

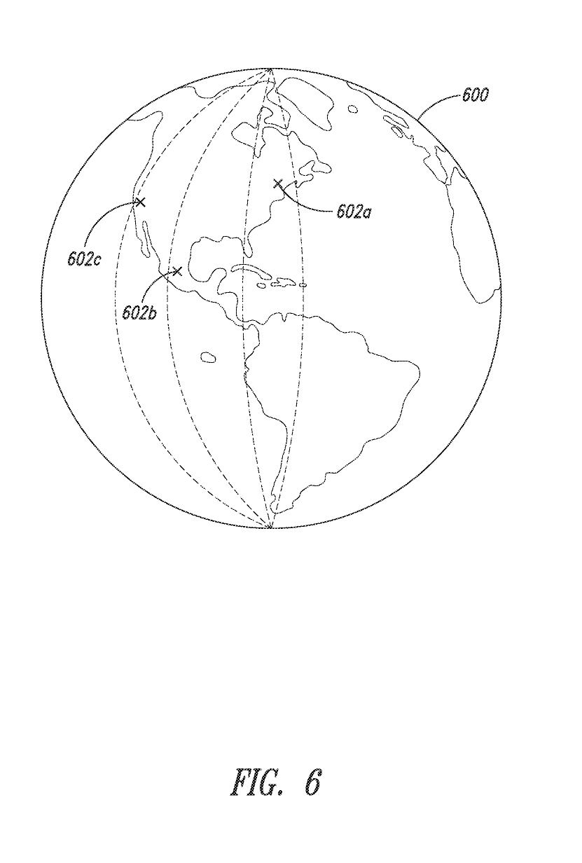

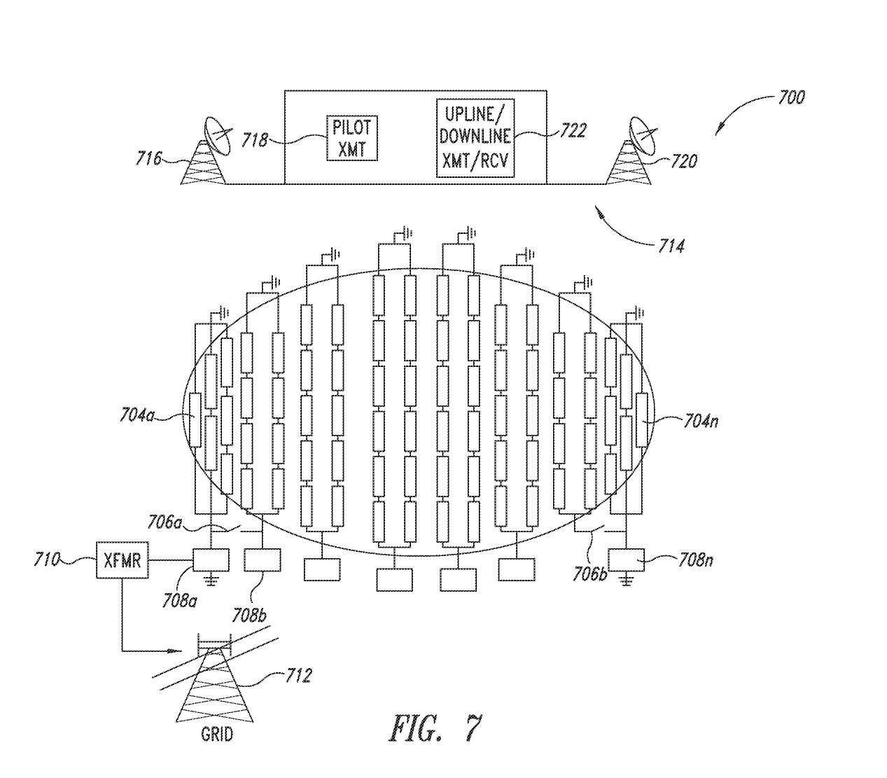

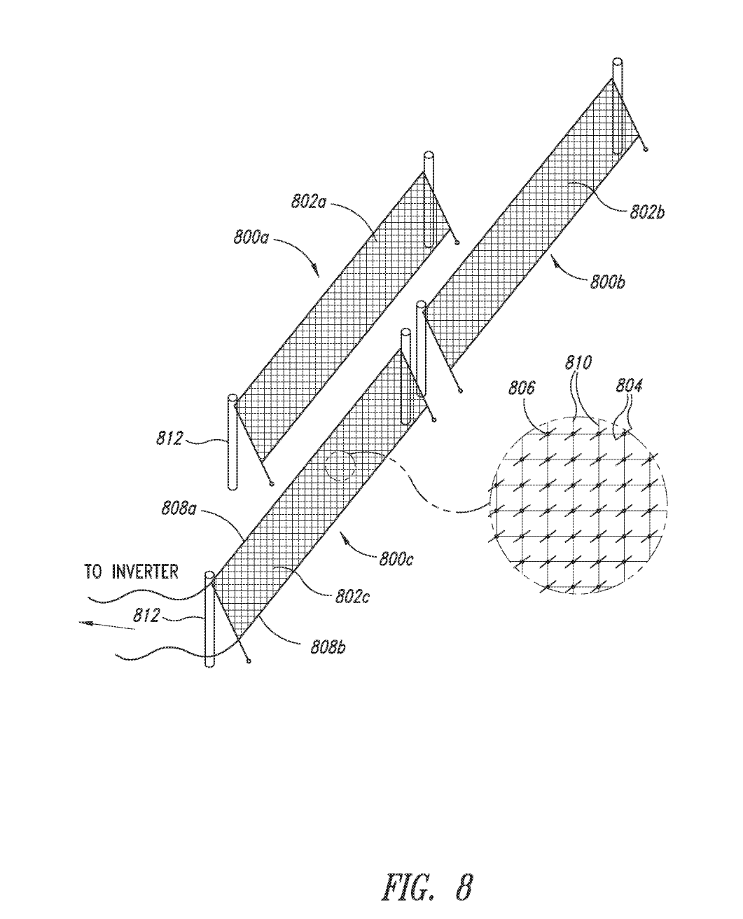

FIG. 6 shows the earth 600 with three ground-based facilities identified by crosses 602a-602c (collectively 602), according to one illustrated embodiment.

The ground-based facility 602 may be advantageously spread across various time zones 604a-604c (collectively 604). For example, a first ground-based facility 602a may be located on the eastern seaboard of the United States or Canada in a first time zone 604a, a second ground-based facility 602b may be located in a central portion of the United States, Canada, or Central America in a second time zone 604b, while a third ground-based facility 602c may be located somewhere in the western United States or Canada in a third time zone 604c. Such may allow power production satellites to supplement ground-based energy production to meet peak demand. Notably, demand typically peaks in the central part of the day, and thus is based on the local time in any particular geographical region. Placement of the power production satellites in GEO allows transmission of power across a large area of the planet. As discussed in more detail below, a cluster or array of power production satellites may be operated as a phased antenna array to direct power to selected ground-based facilities 602. Thus, based on peak demand, a directional component of the phased antenna array may be adjusted to direct power to a desired ground-based facility 602. The microwave beam formed may be at frequencies of high atmospheric transparency, such as 2.45 and 5.8 GHz. Using the higher frequency permits a reduction in the size of the ground based facility without significant loss of total energy received. While FIG. 6 illustrates three ground-based facilities 602, other embodiments may employ greater or lesser number of ground-based facilities. Additionally, some embodiments may employ two or more ground-based facilities 602 co-located in a given time zone, although such would not realize all of the same advantage as distributing ground-based facilities across multiple time zones.

FIG. 7 shows a ground-based facility 700 according to one illustrated embodiment.

The ground-based facility 700 may include a plurality of antennas 704a-704n (collectively 704) arranged to receive power from a cluster or array of power production satellites. In some embodiments, the antennas 704 may take the form of rectennas which transform electromagnetic energy into an electrical current. Where the ground-based facility 700 is located on or approximate the equator, the collection or array of antennas 704 may be arranged in a circular pattern. Where the ground-based facility 700 is located at higher latitudes, the collection or array of antennas 704 may be arranged in a more elliptical pattern. The total area of antennas 704 may be relatively large, for example a circular area having a diameter of approximately 3.72 miles. As illustrated, two or more of the antennas 704 may be electrically coupled in series with one another and/or two or more of the antennas 704 may be electrically coupled in parallel with one another. One or more switches 706a, 706b (only two illustrated in FIG. 7) may allow the antennas 704 to be selectively coupled in series and/or parallel. Such allows a desired level of current and/or voltage to be produced on any given power bus of the ground-based facility 700.

The ground-based facility 700 may include one or more power conversion and/or conditioning systems 708a-708n (collectively 708). The power conditioning and/or conversion system(s) 708 may include one or more DC/DC power converters, DC to AC power inverters, AC to DC power rectifiers, and filters and/or other power conditioning circuits. The ground-based facility may also include one or more transformers 710 (only one illustrated in FIG. 7). The transformer(s) 710 may be employed to raise a voltage of power from the antennas 704 and/or power conditioning and/or conversion system(s) 708 to a voltage suitable for transmission via a power grid 712.

The ground-based facility 700 may further include a communications system 714. The communications system 714 may include a pilot communications system including one or more antennas 716 and transmitters 718 used to transmit a pilot beam to the cluster or array of power satellites to cause the power satellites to function as an antenna array. The antennas 716 may be fixed or steerable. The communications system 714 may also include one or more antennas 720 and uplink/downlink transmitters and/or receivers 722 to provide communications between the ground-based facility 700 and the power production satellites. The uplink/downlink communications system may be used to receive information or data from the power production satellites and/or send instructions and/or data to the power production satellites. Such may, for example, be used to update instructions stored in a control system of the power production satellites. The antennas 720 may be fixed or steerable. While illustrated as being co-located with the array of power receiving antennas 704, the communications system 714 may be separately located.

FIG. 8 shows a number of antennas or rectennas 800a-800c (collectively 800), according to one illustrated embodiment.

The antennas or rectennas 800 take the form of a net 802a-802c (collectively 802) of conductive material and a plurality of dipole receiver elements 804 (only one called out in FIG. 8 for sake of clarity of illustration) with Schottky diodes 806 (only one called out in FIG. 8 for sake of clarity of illustration) to rectify incoming energy into a direct current (DC) electrical power. The net 802 may be electrically isolated from upper and lower support cables 808a, 808b (only one of each called out in FIG. 8 for sake of clarity of illustration). The net 802 acts as a radio frequency reflector, concentrating the transmitted energy on the plurality of dipole receiver elements 804. The dipole receiver elements 804 may be arranged above the respective net 802 by one-half wavelength of the power transmission. The spacing of the wires of the net 802 may also be one-half wavelength of the power transmission. The net 802 also insures that very little radio frequency energy reaches the ground beneath the antennas or rectennas 800.

The receiver elements 804 may be oriented advantageously with respect to the polarization of the incoming power transmission. The DC electrical power produced by the receiver elements 804 may be routed to the upper and lower support cables 808a, 808b via respective leads 810 (only two called out in FIG. 8 for sake of clarity of illustration), transmitting the electricity to the edges of the receiving array for subsequent inversion or use. The net 802 ensures that a substantial portion of the area is open to the passage of precipitation, wind, and light. This permits the ground beneath the net 802 to be substantially unaffected by the presence of the receiver. The nets 802 may be suspended above the ground by one or more poles 812 (only two called out in FIG. 8). The rectennas 800 may be suspended at an angle to accommodate the position of the power production satellites in GEO. Thus in the northern hemisphere, the rectennas 800 may be angled facing generally toward the south. The rectennas 800 may be made with relatively fine wire or cable relative to the overall size of the rectenna 800. Such may reduce the occurrence of ice accumulation. Further, power reception by the rectennas 800 will tend to heat the rectennas 800 and reduce the chance of ice forming.

FIG. 9 shows a method 900 of operating at least one power production satellite, according to one illustrated embodiment.

At 902, a power production satellite is placed into LEO. The power production satellite may be placed into LEO using one more chemical-based rockets (e.g., solid or liquid fuel based). Once in LEO, elements related to a power transducer may be deployed, for example, PV arrays, mirrors, reflectors or other solar concentrators.

At 904, the power transducer of the power production satellite converts solar insolation into electrical power. At 906, the electrical power is employed to drive an electrical propulsion system to boost the power production satellite from LEO to GEO, such as illustrated in FIG. 5. In particular, the power production satellite may be boosted during a portion of each orbit when the power production satellite is receiving solar insolation and able to provide power to the electric drive.

At 908, electrical power produced by the power transducer in response to solar insolation may be used to drive transmission of a power antenna to transmit power as a non-communications electromagnetic power beam toward one or more ground-based facilities from GEO. In some embodiments, the power may be provided as microwave transmissions. A cluster or array of power production satellites may advantageously be operated as a phased antenna array to provide power therefrom to the ground-based facility. Such allows steering of the power beam to selected ground-based facilities. Such also advantageously allows smaller or less massive individual satellites to be launched, making such economically feasible using available launch vehicles without the need to develop or employ heavy lift vehicles.

At 910, from time to time, the power production satellite may change position relative to one or more other satellites. Such may employ a station keeping or other propulsion system, which may be powered via the power transducer.

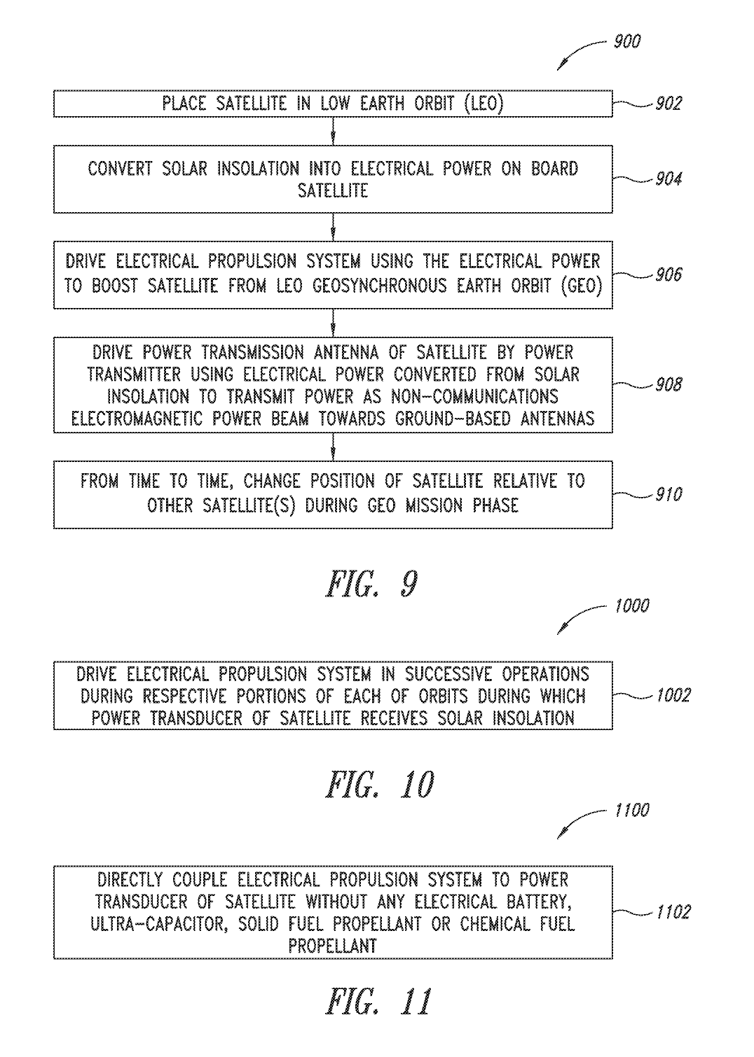

FIG. 10 shows a method 1000, according to one illustrated embodiment.

At 1002, the electric propulsion system is driven in successive operations during respective portions of each orbit during which portions the power transducer of the satellite receives solar insolation, such as is illustrated in FIG. 5 and previously discussed with reference thereto.

FIG. 11 shows a method 1100 of providing power to the propulsion system, according to one illustrated embodiment.

At 1102, the electrical propulsion system is directly coupled to the power transducer of the satellite without any electrical battery or ultra-capacitor. Thus power is supplied to the electrical propulsion system without the use of any additional on-board weight (e.g., battery, ultra-capacitor array, fuel cell, solid fuel propellant, or chemical fuel propellant). Thus, the power production satellite may be boosted from LEO to GEO without the use of any electrical battery or other massive device or expendable fuel. Such may advantageously reduce the weight of the power production satellite and hence the cost of launching the power production satellite into LEO. The use of the same electrical generation system for providing electrical energy for propulsion, then for transmission of power to a celestial body (e.g., earth) may further reduce launch weight.

FIG. 12 shows a method 1200 of operating a power production satellite as part of a phased antenna array, according to one illustrated embodiment.

At 1202, a system on the power production satellite determines a differential between a pilot signal and a reference signal. At 1204, the system on the power production satellite adjusts a phase of the non-communications electromagnetic power beam to form a portion of a phased array antenna with a respective power transmission antenna of other power production satellites.

Various techniques may be employed, similar in some respects to conventional phased antenna arrays. Conventional phased antenna arrays typically include a plurality of radiating elements that are located in fixed geometrical relationship to one another. Each element emits a quasi-spherical wave and the superimposed waves combine constructively or destructively according to phase difference. The wave output by the array is steerable by controlling the phase using phase shifters to shift the relative phases of the elements. In contrast, the cluster or array of satellites, which antennas function as elements of the phased antenna array, are not physically fixed with respect to one another, thus the relative positions and/or distances between the elements may vary to some degree.

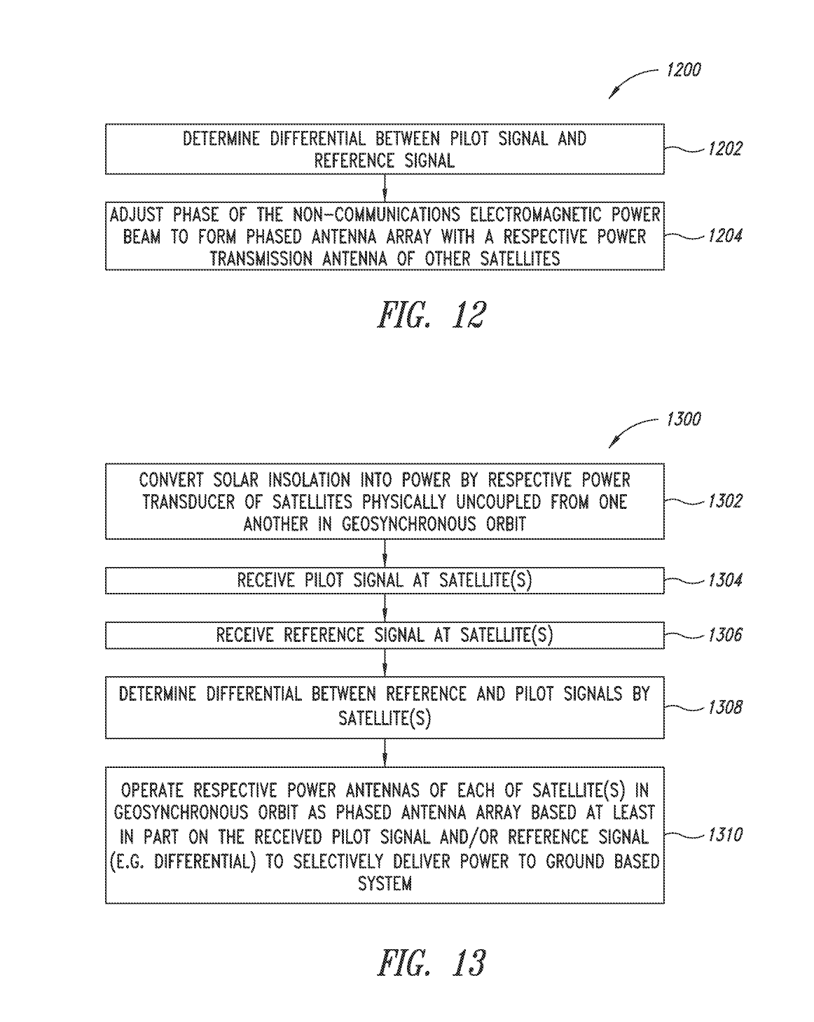

FIG. 13 shows a method 1300 of operating a number of power production satellites to deliver power to a ground-based facility, according to one illustrated embodiment.

At 1302, each of at least some of the satellites convert solar insolation into power using respective power transducers. As previously noted, the satellites may be physically uncoupled from one another and in GEO.

At 1304, the satellites receive a pilot signal. At 1306, at least some of the satellites receive a reference signal. At 1308, at least some of the satellites determine a differential between the reference and pilot signals. At 1310, at least some of the satellites operate respective power antennas as portions of a phased antenna array based at least in part on the received pilot signal and/or reference signal or differential thereof to selectively deliver power to a ground-based facility. The pilot signal and/or reference signal allows the satellites to form a synthetic aperture and to direct power to the desired ground-based facility. The use of a pilot signal allows each individual satellite to form a return transmission beam, without a precise distance relationship with other satellites in the array. The beam is steered and phased electronically, using the local reference signal, as compared with the phase and directionality of the pilot signal. Phase shifters within each transmission element allow the collection of satellites to act as a single large phased array, without physical or electrical connection. The only connection between individual satellites is in the form of RF energy. The timing and phase information is computed and used in real-time, on each independent satellite. The local reference signal, shared among the independent satellites provides the time-base for the computation of the differential reception of the pilot beam. This information provides precise phase and steering information for the transmitting antenna elements. As previously noted, the power takes the form of non-communications transmission of energy (e.g., microwave) that is typically not modulated with information. The amount of power exceeds the amount of power of typical communications transmissions.

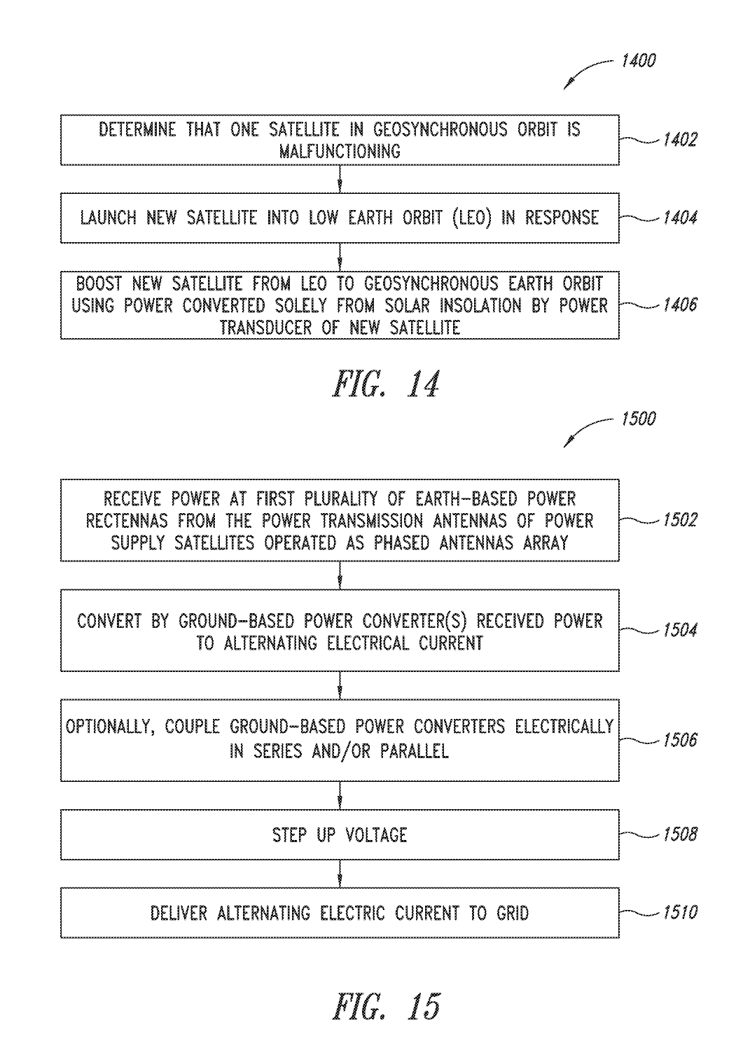

FIG. 14 shows a method 1400 of maintaining a cluster or array of power production satellites, according to one illustrated embodiment.

At 1402, a ground-based facility determines that a satellite in GEO is malfunctioning. At 1404, a new satellite is launched into LEO in response to the determination. At 1406, the new satellite is boosted from LEO to GEO using power converted solely from solar insolation by a power transducer of the new satellite. Thus, a malfunctioning satellite may be replaced. The malfunctioning satellite may be parked in a higher orbit or maybe purposely de-orbited if such can be performed safely. Since any one satellite forms only a small portion of the cluster or array, power may still be effectively delivered to the ground-based facility until a replacement reaches GEO. Additionally or alternatively, “hot” spare satellites may already be in position in GEO, ready to be positioned for replacement of a failing unit.

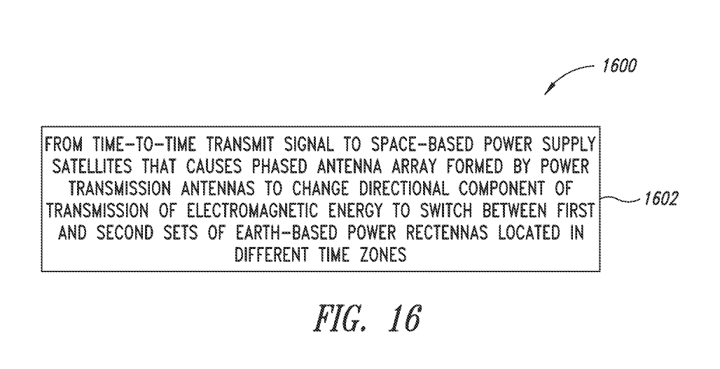

FIG. 15 shows a method 1500 of operating a ground-based facility, according to one illustrated embodiment.

At 1502, the antennas or rectennas of the ground-based facility receive power from power transmission antennas of a number of power production satellites operated as a phased antenna array. At 1504, ground-based power converters and/or conditioners convert the power received by the rectennas into an alternating electric current. Optionally, at 1506, ground-based power converters may be electrically coupled in series and/or parallel to achieve a desired magnitude of current and/or voltage, for example via one or more switches (e.g., relays, contactors). At 1508, a transformer may be used to step up a voltage of the AC power. At 1510, the AC power may be delivered to an electrical grid.

FIG. 16 shows a method 1600 of operating a ground-based facility to receive power from a plurality of power production satellites in GEO, according to one illustrated embodiment.

At 1602, from time-to-time, signals are transmitted to the space-based power production satellites, which cause the power production satellites to form a phased antenna array to change a directional component of transmission of electromagnetic energy. Such allows switching between first and second sets of earth-based power rectennas. As previously discussed, the first and second sets of power rectennas may be located in different time zones. Such advantageously allows power to be selectively delivered where and when needed.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other spaced-based power production systems, not necessarily the exemplary spaced-based power production system to deliver energy to ground-based facilities generally described above.

The various embodiments described above can be combined to provide further embodiments. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A satellite, comprising: a power transducer that converts solar insolation into electrical power; and an electrical propulsion system coupled to the power transducer to receive at least a portion of the electrical power converted from the solar insolation and operable during at least one mission phase to boost the satellite from a low earth orbit to a geosynchronous earth orbit.

2. The satellite of claim 1 wherein the electrical propulsion system is configured to boost the satellite from the low earth orbit in successive operations which each occur during a respective portion of each of a plurality of orbits during which the power transducer receives the solar insolation.

3. The satellite of claim 1 wherein the electrical propulsion system is directly coupled to the power transducer without any intervening electrical battery or ultra-capacitor.

4. The satellite of claim 1, further comprising:
at least one power transmission antenna that can be oriented toward the earth while the satellite is in the geosynchronous earth orbit; and
at least one power transmitter coupled to drive the at least one power transmission antenna with at least a portion of the electrical power converted from the solar insolation by the power transducer to transmit power that is not modulated with any communications data from the satellite towards the at least one ground-based power reception antenna.

5. The satellite of claim 1, further comprising:
at least one power transmitter operable to cause at least a portion of the electrical power converted from the solar insolation by the power transducer to be provided as a non-communications electromagnetic power transmission towards at least one earth-based receiver.

6. The satellite of claim 1, further comprising:
at least a first antenna to receive a pilot signal from a ground-based transmitter;
at least a second antenna to receive a reference signal from a space-based transmitter; at least one power transmission antenna that can be oriented toward the earth while the satellite is in the geosynchronous earth orbit; and
at least one power transmitter operable to cause at least a portion of the electrical power converted from the solar insolation by the power transducer to be provided as a non-communications electromagnetic power transmission towards at least one earth-based receiver with a phase that is responsive to a differential between the pilot signal and the reference signal.

7. The satellite of claim 6, further comprising:
a controller that determines the differential between the pilot signal and the reference signal, wherein the satellite is one or a plurality of satellites each of which provides a respective electromagnetic power transmission towards the at least one earth-based receiver with respective phases controlled to form a phased array antenna.

8. The satellite of claim 7 wherein the electrical propulsion system is operable during at least another mission phase during geosynchronous earth orbit to change a position of the satellite relative to at least one other satellite.

9. The satellite of claim 1 wherein the power transducer includes at least one of a photovoltaic array system or a closed loop boiler and turbine system and the electrical propulsion system includes at least one of a Hall effect drive or an ion drive.

10. A method of operating a satellite, comprising:
placing the satellite in a low earth orbit;
converting solar insolation into electrical power on board the satellite; and
driving an electrical propulsion system using the electrical power converted from the solar insolation to boost the satellite from the low earth orbit to a geosynchronous earth orbit.

11. The method of claim 10 wherein driving an electrical propulsion system using the electrical power converted from the solar insolation to boost the satellite from the low earth orbit to a geosynchronous earth orbit includes driving the electrical propulsion system in successive operations which each occur during a respective portion of each of a plurality of orbits during which the power transducer of the satellite receives the solar insolation.

12. The method of claim 10 wherein driving the electrical propulsion system in successive operations which each occur during a respective portion of each of a plurality of orbits during which a power transducer of the satellite receives the solar insolation includes driving the electrical propulsion system for successively longer periods during each successive operation to successively circularize the orbit of the satellite.

13. The method of claim 10 wherein driving an electrical propulsion system using the electrical power converted from the solar insolation to boost the satellite from the low earth orbit to a geosynchronous earth orbit includes directly coupling the electrical propulsion system to a power transducer of the satellite without any electrical battery, ultra-capacitor, solid fuel propellant or chemical fuel propellant.

14. The method of claim 10, further comprising:
driving at least one power transmission antenna by a power transmitter with at least a portion of the electrical power converted from the solar insolation by a power transducer of the satellite to transmit power that is a non-communications electromagnetic power beam from the satellite towards at least one ground-based antenna.

15. The method of claim 14, further comprising:
determining a differential between a pilot signal and a reference signal; and
adjusting a phase of the non-communications electromagnetic power beam to form a phased antenna array with a respective power transmission antenna of each of a plurality of other satellites.

16. The method of claim 14, further comprising:
changing a position of the satellite relative to at least one other satellite during a geosynchronous earth orbit mission phase.

17. A space-based power supply system to supply power to remote facilities, comprising:
a plurality of satellites, each of the satellites in geosynchronous orbit and physically uncoupled from one another, at least three of the satellites each including a respective power transducer that converts solar insolation into electrical power and a respective power transmission system including at least one power transmission antenna, wherein each of the at least three satellites receive at least one signal to synchronize the power transmission antennas of each of the power transmission systems as a phased antenna array to transmit the electric power converted from the solar insolation in the form of electromagnetic energy that is not modulated with communications data to a remote non-space-based facility.

18. The space-based power supply system of claim 17 wherein one of the plurality of satellites does not include a respective power transmission system, and includes a synchronization system that includes at least one synchronization antenna and at least one synchronization transmitter that transmits a reference signal to at least some of the at least three satellites which include the respective power transmission systems, which reference signal provides a basis to synchronize a phase of each of the power transmission antennas as a phased antenna array.

19. The space-based power supply system of claim 17 wherein one of the at least three satellites which include a respective power transmission system further includes a synchronization system that includes at least one synchronization antenna and at least one synchronization transmitter that transmits a reference signal to at least some of the other ones of the at least three satellites, which reference signal provides a basis to synchronize a phase of each of the power transmission antennas as a phased antenna array.

20. The space-based power supply system of claim 19 wherein each of the at least three satellites includes a receiver that receives a pilot signal from the non-space-based facility.

21. The space-based power supply system of claim 20 wherein each of the at least three of the satellites include a respective controller that controls the respective power transmission system based at least in part on a differential between the pilot and the reference signals to achieve the phased antenna array.

22. The space-based power supply system of claim 17, wherein each of the at least three satellites includes a respective electric propulsion system coupled to receive electrical power from the at least one power transducer and selectively operable to change a position of the satellite with respect to the other ones of the at least three satellites while in geosynchronous orbit.

23. The space-based power supply system of claim 17, wherein the electric propulsion system is coupled to receive power from the respective power transducer and is further operable to boost the satellite from the geosynchronous orbit from a low earth orbit solely using electrical power converted from the solar insolation by the power transducer.

24. A method of operating a plurality of satellites to provide power from space, the method comprising:
converting solar insolation into power by a respective power transducer of each of a plurality of satellites in geosynchronous orbit, at least two of the satellites physically uncoupled from one another;
receiving a pilot signal at each of at least some of the satellites in geosynchronous orbit; and
operating a respective power antenna of each of at least some of the satellites in geosynchronous orbit a phased antenna array based at least in part on the received pilot signal to selectively delivering at least 1 Megawatts of power from the phased antenna array.

25. The method of claim 24 wherein operating a respective power antenna of each of at least some of the satellites in geosynchronous orbit a phased antenna array based at least in part on the received pilot signal to selectively delivering at least 1 Megawatt of power from the phased antenna array includes operating a respective power antenna of each of at least some of the satellites to transmit electromagnetic power that has not been modulated with communications information.

26. The method of claim 24, further comprising:
receiving a reference signal by at least some of the satellites;
determining a differential between the received reference and pilot signals; and
operating a respective power transmitter of each of at least some of the satellites based on the determined differential between the received reference and pilot signals.

27. The method of claim 24, further comprising:
boosting each of the satellites from low earth orbit into a respective geosynchronous orbit using power converted on board the satellite solely from solar insolation.

28. The method of claim 24, further comprising:
adjusting a position of one of the satellites with respect to at least one other of the satellites using power converted on board the satellite solely from solar insolation.

29. The method of claim 24, further comprising:
determining that one of the satellites in geosynchronous orbit is malfunctioning;
launching a new satellite into a low earth orbit in response to determining that one of the satellites in geosynchronous orbit is malfunctioning; and
boosting the launched new satellite from the low earth orbit to the geosynchronous orbit using power converted solely from solar insolation by a power transducer of the new satellite.

30. A ground-based power supply system, comprising:
a pilot signal transmitter that provides a basis to synchronize transmission from each of a plurality of power transmission antennas of a plurality space-based power supply satellites to operate as a phased array antenna;
a first plurality of earth-based power rectennas positioned to receive power in the form of electromagnetic energy transmitted from the power transmission antennas of the plurality of power supply satellites when power transmission antennas of the power supply satellites operate as the phased antenna array; and
at least one power converter coupled to receive power from at least one of the power rectennas and configured to convert the received power to an alternating electric current for delivery to a power grid.

31. The ground-based power supply system of claim 30 wherein each of the first plurality of power rectennas comprise a net.

32. The ground-based power supply system of claim 30 wherein the first plurality of power rectennas form an elliptical rectenna array and the at least one power converter includes at least three power converters distributed at various locations about the elliptical rectenna array.

33. The ground-based power supply system of claim 30 wherein the at least one power converter includes an inverter configured to convert a direct electrical current to an alternating electrical current and a transformer to step up a voltage of the alternating electrical current.

34. The ground-based power supply system of claim 30, further comprising:
a number of switches selectively operable to electrically couple at least two of the rectennas of the first plurality in parallel to one another.

35. The ground-based power supply system of claim 30, further comprising:
a number of switches selectively operable to electrically couple at least two of the rectennas of the first plurality in series to one another.

36. The ground-based power supply system of claim 30, further comprising:
a switching system operable to switch the transmission of electromagnetic energy by the plurality of supply satellites to at least a second plurality of earth-based power rectennas that form a second rectenna array remotely located from the first rectenna array.

37. The ground-based power supply system of claim 36 wherein the first and the second rectenna arrays are located in different time zones from one another.

38. A method of operating a ground-based power supply system, comprising:
transmitting a pilot signal that provides a basis to synchronize transmission from each of a plurality of power transmission antennas of a plurality space-based power supply satellites to operate as a phased array antenna;
receiving power in the form of electromagnetic energy at a first plurality of earth-based power rectennas from the power transmission antennas of the plurality of power supply satellites when power transmission antennas of the power supply satellites operate as the phased antenna array; and
converting by at least one ground-based power converter the power received at the first plurality of power rectennas to an alternating electric current for delivery to a power grid.

39. The method of claim 38, further comprising:
coupling at least two ground-based power converters electrically in at least one or series or parallel.

40. The method of claim 38, further comprising:
from time-to-time transmitting a signal to the space-based power supply satellites that causes phased antenna array formed by the power transmission antennas of the space-based power supply satellites to change a directional component of the transmission of electromagnetic energy to switch between the first plurality of earth-based power rectennas and at least a second plurality of earth-based power rectennas located in different time zone than the first plurality of earth-based power rectennas.
